(19) United States
(12) Patent Application Publication
(10) Pub. No.: US 2009/0129541 A1
(43) Pub. Date: May 21, 2009

(54) IN SITU INDICATOR DETECTION AND QUANTITATION TO CORRELATE WITH AN ADDITIVE

(75) Inventors: IVAN WEI-KANG ONG, Charlotte, NC (US); FRANKLIN WRENN WILKINSON, China Grove, NC (US)

Correspondence Address: MICROBAN PRODUCTS COMPANY, 11400 VANSTORY DRIVE, HUNTERSVILLE, NC, 28078, US

(73) Assignee: MICROBAN PRODUCTS COMPANY, Huntersville, NC (US)

(21) Appl. No.: 12/275,638

(22) Filed: Nov. 21, 2008

Related U.S. Application Data
(60) Provisional application No. 60/989,737, filed on Nov. 21, 2007.

(51) Int. Cl. G01T 1/36; G03C 1/72; C08J 3/22

(52) U.S. Cl. 378/44; 252/600; 523/351

(57) ABSTRACT

An additive formulation includes a carrier material, a first additive present in the carrier material at a first additive concentration, and a tracer present in the carrier material at a first tracer concentration. The tracer is a metal amenable to detection by X-ray fluorescence analysis. Further embodiments include a manufactured article having incorporated therein the additive formulation. A method is also disclosed for detecting an additive in a manufactured article, the method involving application of X-ray fluorescence analysis of the tracer element.

### CROSS-REFERENCE TO RELATED APPLICATIONS

This application claims priority to U.S. Ser. No. 60/989737, filed on 21 Nov. 2007.

### FIELD OF THE INVENTION

The present invention relates to the qualitative and/or quantitative measurement of a manufacturing additive, and in particular to a compound and method for detecting a compound and quantitatively measuring same to correlate with an added amount of one or more antimicrobial agents.

### BACKGROUND OF THE INVENTION

Manufacture of polymer goods commonly involves the inclusion in the polymeric resin of additives. Frequently, an additive is present in the polymer in a concentration too low to detect and/or assess without resort to laboratory analysis techniques. In other instances, the additive may interfere with standard laboratory analytic methodologies by causing false positives or physically affecting laboratory equipment. As well, some additives may require analytical methods which can be complicated, expensive, hazardous and/or not widely available.

Wet chemistry methods, undertaken using standard laboratory methods, often are time-consuming and produce a single analysis over a period of hours. Turn-around time in commercial laboratories typically is measured in days or weeks.

A need therefore exists for a method of detecting an added compound in an article, such as one constructed of a polymeric resin.

### BRIEF DESCRIPTION OF THE DRAWINGS

FIG. 1 is a flowchart diagram showing steps in an X-ray fluorescence detection scheme.

FIG. 2 is a diagram of a handheld X-ray fluorescence analyzer in use on a sample as described herein.

### DETAILED DESCRIPTION OF PREFERRED EMBODIMENT(S)

In this document, certain terms such as antimicrobial, antibacterial, antifungal, microbistatic, cement, cementitious, and the like may be used. While not intended to be limiting, the following definitions are provided as an aid to the reader.

The term “antimicrobial” as used herein includes biostatic activity, i.e., where the proliferation of microbiological species is reduced or eliminated, and true biocidal activity where microbiological species are killed. Furthermore, the terms “microbe” or “antimicrobial” should be interpreted to specifically encompass bacteria and fungi as well as other single-celled organisms such as mold, mildew and algae.

As used herein, a “material” may be a chemical element, a compound or mixture of chemical elements, or a compound or mixture of a compound or mixture of chemical elements, wherein the complexity of a compound or mixture may range from being simple to complex. Materials may include metals (ferrous and non-ferrous), metal alloys, polymers, rubber, glass, ceramics, etc.

As used herein, “element” means a chemical element of the periodic table of elements, including elements that may be discovered after the filing date of this application.

The following description of the preferred embodiment(s) is merely illustrative in nature, using an antimicrobial agent as the exemplary additive. These instructive embodiments are in no way intended to limit the scope of the disclosed additive indicator, its application, or uses.

Polymer Article Manufacture

In typical embodiments of an antimicrobial article, a quantity of an antimicrobial agent is compounded with the base resin from which the article is to be made, resulting in a masterbatch having the antimicrobial agent incorporated therein at a higher concentration than the final target concentration in the finished polymer article.

In manufacture, the masterbatch resin is mixed with unadulterated resin (e.g., in pellet form) in a specific ratio conventionally known as a letdown rate. In this manner, the additive components of the masterbatch resin are diluted into the polymer resin mixture to achieve the desired final concentration.

Examples of polymer goods include, without limitation, cutting boards, food and household storage containers, trash cans, footwear outsoles, caulking, filtration elements for water and air filters, Jacuzzi and whirlpool spas and tubs, computer peripheral devices, and automobile components and aftermarket parts.

Conventionally, concentrations of antimicrobial agents in polymer articles are as low as about 50 ppm, based upon the weight of the cementitious composition. A practical upper end to the useful concentration range is dependent on the antimicrobial agent, the material in which it is incorporated, and the intended use environment of the article. Generally speaking, however, antimicrobial agent concentrations may range as high as about 100,000 ppm.

Other additives similarly can be used in the production of the material. Examples of such additives include, without limitation, pigments and colorants, binders, plasticizers, anti-fouling or antimicrobial agents, anti-static agents, flame retardants, processing aids (e.g. antislip agents, lubricants), heat stabilizers, ultraviolet radiation stabilizers, ultraviolet radiation absorbers, and the like

Cementitious Article Manufacture

In a second embodiment, a product can be a cementitious article such as a grout mixture, a cement-based tile, a sculpture or decorative item, a countertop material, a building or construction article, and the like.

For such cementitious articles, an antimicrobial agent or other additive can be introduced directly into the cement-based mixture in dry form (e.g., powder) or liquid stream. The additive can be compounded with other components of the cementitious composition from which the article will be made.

In an exemplary cementitious article, the concentration of the antimicrobial agent can be in a range from about 250 ppm to about 10,000 ppm based upon the weight of the cementitious composition.

Textile Manufacture

In a third embodiment, the manufactured article can be a textile good or a textile-based good. An example of such goods include, without limitation, goods manufactured in whole or in part with synthetic fibers having an antimicrobial agent incorporated therein.

In a conventional antimicrobial textile good, the concentration of the antimicrobial agent can be in a range from about 250 ppm to about 10,000 ppm. The specific concentration would be selected in large part based on the polymer, the antimicrobial agent(s) employed, the polymer manufacturing method, any post-polymerization treatments and/or finishing steps applied to the textile, and the like.

XRF Technology

Techniques for analyzing or measuring the elemental composition of a substance, such as coal, using X-ray fluorescence (XRF), are well-known in the art. An example of one technique is disclosed in U.S. Pat. No. 6,130,931, the disclosure of which is incorporated herein by reference.

X-ray fluorescence spectroscopy has long been a useful analytical tool in the laboratory for classifying materials by identifying elements within the material, both in academic environments and in industry. The use of characteristic x-rays such as, for example, K-shell or L-shell x-rays, emitted under excitation provides a method for positive identification of elements and their relative amounts present in different materials, such as metals and metal alloys.

For example, input radiation striking matter causes the emission of characteristic K-shell x-rays when a K-shell electron is knocked out of the K-shell by incoming radiation and is then replaced by an outer shell electron. The outer electron, in dropping to the K-shell energy state, emits x-ray radiation characteristics of the atom.

The energy of emitted x-rays depends on the atomic number of the fluorescing elements. Energy-resolving detectors can detect the different energy levels at which x-rays are fluoresced, and generate an x-ray signal from the detected x-rays. This x-ray signal may then be used to build an energy spectrum of the detected x-rays, and from the information, the element or elements which produced the x-rays may be identified.

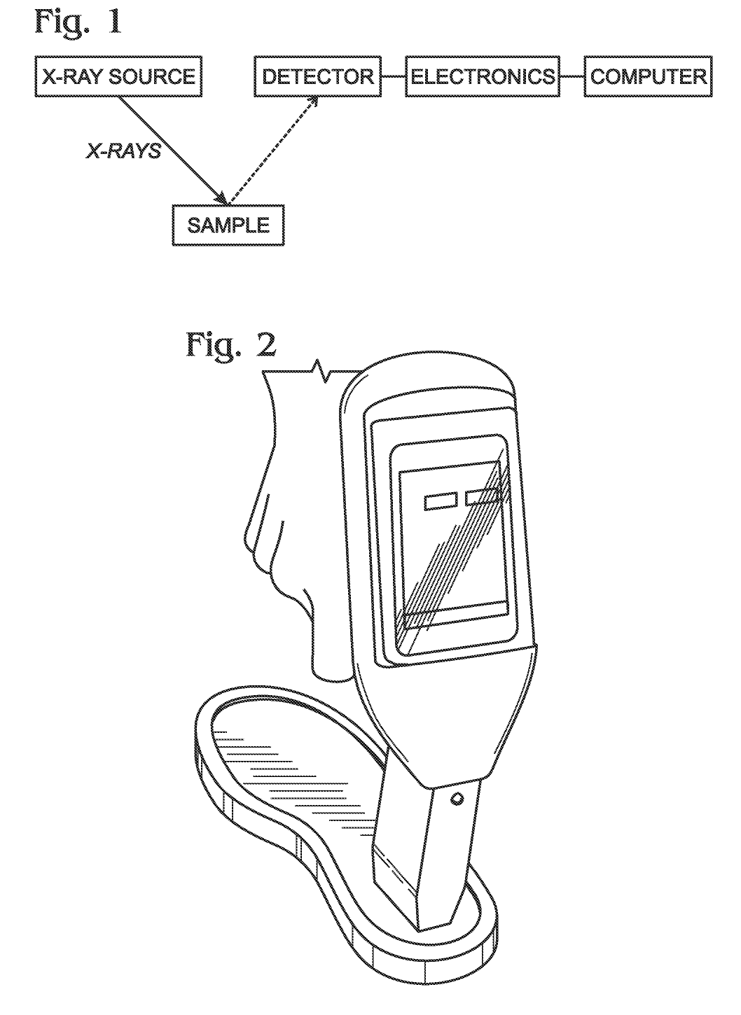

Output fluorescent x-rays are emitted isotopically from an irradiated element 10, and the detected output radiation depends on the solid angle subtended by the detector 12 and any absorption of this radiation prior to the radiation reaching the detector (FIG. 1).

In the particular embodiment shown in FIG. 1, raw detection data is outputted from the detector 12 to electronics 14, which can assess the incoming raw data (e.g. wavelength and pattern matching, as discussed above). Alternatively or additionally, computer 16 can be employed to analyze and/or display detection results.

The lower the energy of an x-ray, the shorter the distance it will travel before being absorbed by air. Thus, when detecting x-rays, the amount of x-rays detected is a function of the quantity of x-rays emitted, the energy level of the emitted x-rays, the emitted x-rays absorbed in the transmission medium, the angles between the detected x-rays and the detector, and the distance between the detector and the irradiated material.

In one embodiment of an XRF analyzer, the unit can be employed to detect a broad variety of indicators, including without limitation titanium, chromium, manganese, iron, nickel, copper, zinc, arsenic, rubidium, strontium, zirconium, cadmium, tin, antimony, barium, mercury, lead, silver, selenium, cobalt, tungsten, bromine, and thallium. As well, an indicator can be a compound comprising one or more of the above elements.

Detection of Indicator Presence

In the above instances, the specific identity of the antimicrobial agent(s) used is not critical to the present indicator technology. It is significant only that an additive compound be added, and that a need exists to conveniently assess the article to determine if the additive has been incorporated into it and, optionally, at what level.

The use of XRF technology is employed advantageously to detect the presence of one or more indicators (i.e., tracer elements) in the manufactured good. In basic terms, a first indicator can be compounded into a polymeric masterbatch at a predetermined concentration. As the additive (e.g. antimicrobial agent) also is compounded into the masterbatch at a selected concentration, the ratio of additive to indicator is constant and known to the user.

After proper letdown and manufacture, the theoretical (target) additive concentration in the finished article is known. It is therefore anticipated by the user that the antimicrobial agent additive: (a) be present in the polymer material of the manufactured article, and (b) at a predetermined final concentration. The indicator likewise is expected to be present in the finished article at a predetermined concentration.

In some cases, an initial concern arises as to whether or not the additive, by way of masterbatch, is correctly introduced into the manufacturing process. As a first matter, then, the manufacturing process can be quantitatively assessed to verify that the masterbatch was successfully added to the polymer starting material. Quantitative analysis using the present indicator composition and methodology can be understood by review of the following example.

### EXAMPLE 1

An ethyl vinyl chloride (EVA) masterbatch was prepared incorporating Additive ZO1™ (Microban Products Company, Huntersville, N.C.), such that the masterbatch contained the antimicrobial agent zinc pyrithione at a concentration of 100,000 ppm by weight of the EVA masterbatch.

Zirconium dioxide was used as an indicator at 6477.5 ppm by weight of the EVA masterbatch. Zirconium was chosen as the indicator because it is unique, inert with respect to the polymer material, not present in unadulterated EVA polymer compositions, and easy to quantitatively analyze. Rather than analyzing for zinc pyrithione directly, the user instead analyzes for the zirconium tracer, which tells how much zinc pyrithione is present in the EVA sample material.

The inventive masterbatch was used at a letdown ratio of 1.5% in unadulterated EVA to manufacture a sandal outsole. Additional colorants in the EVA polymer conferred an opaque black appearance to the finished outsole material.

The theoretical concentrations of zinc pyrithione and zirconium dioxide in the exemplary manufactured article are 1500 ppm and 97.16 ppm, respectively.

Many other ingredients can mask the presence of the zinc pyrithione, making it difficult to conventionally analyze the treated material for this compound's presence and concentration. It is desirable to easily determine if the article manufacturer has correctly added zinc pyrithione to ensure product performance conferred by antimicrobial agent addition.

XRF measurements were made with an Alpha 4000 Handheld X-Ray Fluorescence Analyzer (Innov-X Systems, Woburn, Mass.) driven by an HP iPAQ PocketPC device (Hewlett-Packard, Palo Alto, Calif.).

Use of the Alpha 4000 analyzer is straightforward: the user holds the nose of the Alpha 4000 analyzer (D in FIG. 2) against the sample material and pulls the trigger (FIG. 2). The instrument reads for approximately 20-30 seconds—with longer readings resulting in greater accuracy—and displays the concentration readings. A palm-top computing device is built into the XRF instrument and provides both analysis and a user interface. The Alpha 4000 analyzer can be used to measure for any of several different indicators.

Using the Alpha 4000 analyzer D, the EVA outsole article 20 was analyzed. Zirconium was detected in every outsole article sample. Based on the addition of zirconium to the masterbatch and the lack of zirconium in the untreated EVA raw polymer material, it can be concluded that masterbatch was successfully admixed with the unadulterated EVA starting material.

Quantitative Determination of Indicator Concentration

The Alpha 4000 analyzer and methodology as described above can further be employed to determine the concentration of indicator in the EVA outsole article.

### EXAMPLE 2

Using the same sample as in Example 1, the outsole material was analyzed at three stages in manufacture: thin sheet (2 mm thick), slit foam (4 mm), and thick foam (36 mm). for each stage, three pieces were used, with each piece assayed at two different locations.

For each stage, zirconium was detected in samples. The mean levels of zirconium observed in the three stages were 164 ppm, 205 ppm, and 148 ppm, respectively. Based on the concentration of zirconium in the masterbatch (6477.5 ppm), an actual letdown rate of ˜2.66% initially was calculated. This information can be useful in guiding adjustments to the manufacturing process in order to achieve the target result in the finished good.

It was found that the specific polymer tested, as well as its density and overall thickness, impacted the zirconium detection. One of ordinary skill in the XRF art should understand that generation and application of a specific calibration curve will improve accuracy.

It further should be noted that a trace level of zirconium contamination in the EVA raw material can be tolerated by the present method. So long as the baseline level in the untreated material is known, the additional zirconium (or other indicator, if desired) can be measured and used to determine the occurrence and degree of letdown.

Quantitative Correlation of Indicator Presence with Additive Concentration

It should be readily appreciated that the concentration of additive (e.g. antimicrobial agent) in the finished article can be calculated by reference to either the observed concentration of indicator in the article or a lookup table of output radiation signal strengths and additive concentrations.

Continuing with the above outsole, it is known that the ratio of zinc pyrithione to zirconium dioxide in the masterbatch was 15.438:1. Using this ratio, it was calculated that the zinc level in the three stage samples was 2532 ppm, 3165 ppm, and 2285 ppm, respectively.

To assess the calculated zinc concentrations based on detected zirconium, XRF analysis was undertaken directly for zinc. Testing returned zinc concentration levels of 965 ppm, 1380 ppm, and 946 ppm, respectively.

The above detection results for zirconium and zinc in the experimental samples highlights that the particular material used in the substrate can affect quantitative XRF. It was discovered that the identity, density, and volume of the EVA polymer impacted the observed results.

One of ordinary skill in the X-ray fluorescence art will appreciate that calibration can be achieved for the finished good based on its substrate material. Generation of a calibration curve, or in the alternative a normalization data-processing step, based on production samples and correlated to actual indicator concentrations (e.g. via conventional testing) will enable the user to obtain accurate quantitative readings in the field from the XRF analyzer.

Even without calibration that yields accurate quantitative readings, it should be noted that an error range of ±about 10% in the antimicrobial agent concentration would not significantly impact efficacy by laboratory analysis. For other additives for which narrower tolerances exist, however, it may be necessary to undertake calibration of some sort to correlate XRF readings with manufactured articles having the desired property conferred by the additive of interest.

Zinc pyrithione is useful for this example, as zinc can itself be assayed in the finished good using XRF technology. This compound therefore permitted direct-measurement confirmation of the zinc pyrithione concentration calculated using the zirconium correlation data.

Alternatively, the present method can be employed with a variety of non-metallic antimicrobial agents, as well as other additives as previously mentioned. Qualitative analysis is rapid and sufficiently accurate to be useful in manufacturing; after proper calibration, the present method can be advantageously employed to assess and/or optimize letdown rates.

Energy Dispersive X-Ray Spectroscopy

Energy dispersive X-ray spectroscopy (EDS or EDX) is a similar detection technology which can be employed in place of or in addition to X-ray fluorescence.

There are four main components of the EDX analyzer: the beam source; the X-ray detector; the pulse processor; and the analyzer. An EDX system generally is sized to sit on a bench or counter top and frequently is used in tandem with scanning electron microscopy. A detector is used to convert X-ray energy into voltage signals; this information is sent to a pulse processor, which must measure the signals and pass them onto an analyzer for data display and analysis.

To stimulate a detectable response from a test sample, an electron or photon beam is aimed into the sample to be characterized. At rest, an atom within the sample contains ground state (unexcited) electrons situated in concentric shells around the nucleus. The incident beam excites an electron in an inner shell, prompting its ejection and resulting in the formation of an electron hole within the atom's electronic structure. An electron from an outer, higher-energy shell then fills the hole, and the excess energy of that electron is released in the form of an X-ray. The release of X-rays creates spectral lines that are highly specific to individual elements; thus, the X-ray emission data can be analyzed to characterize the sample in question.

Information on the quantity and kinetic energy of ejected electrons is used to determine the binding energy of the liberated electrons. Binding energy is element-specific and thus allows chemical characterization of a test sample.

The above sample materials were assessed via EDX analysis, and results compared with both those obtained through XRF and analytical chemistry. EDX measurements were found to be more accurate and less perturbed by the polymer and its physical parameters than was the XRF handheld analyzer.

However, EDX detection equipment at present is bulky and non-portable. Either system can be employed effectively in the method disclosed herein, with the specific choice governed by the needs and preferences of the user.

Use of Multiple Indicators

In some instances, it may be advantageous to utilize a plurality of discrete indicators incorporated into the masterbatch in a specific ratio. This method embodiment provides greater accuracy by calculating based on a plurality of measurements. As well, fewer false positives will be obtained by contaminants mimicking the indicators.

Even where a particular indicator is present in the raw material or a different component used to produce the finished good, the present method compares the plurality of indicators and applies the known ratio from the masterbatch to determine letdown rate and/or concentration.

Among the combinations that can be chosen, a mixture of strontium and rubidium is particularly advantageous for most polymer compositions. These elements are unlikely to be found in the base resin or in chemicals used in manufacturing, such as catalysts. Of course, the particulars of the contemplated manufacture should dictate which elements are suitable for use as indicators.

It will be readily understood by those persons skilled in the art that the present indicator compositions and methods are susceptible of broad utility and application. Many embodiments and adaptations other than those herein described, as well as many variations, modifications and equivalent arrangements, will be apparent from or reasonably suggested to one of ordinary skill by the present disclosure and the foregoing description thereof, without departing from the substance or scope thereof.

Accordingly, while the present composition and methods have been described herein in detail in relation to its preferred embodiment, it is to be understood that this disclosure is only illustrative and exemplary and is made merely for purposes of providing a full and enabling disclosure. The foregoing disclosure is not intended or to be construed to limit or otherwise to exclude any such other embodiments, adaptations, variations, modifications and equivalent arrangements.

What is claimed is:

1. An additive formulation, comprising:
a carrier material;
a first additive present in the carrier material at a first additive concentration; and
a first tracer present in the carrier material at a first tracer concentration;
wherein the first tracer is a metal amenable to detection by X-ray fluorescence analysis.

2. The additive formulation of claim 1 wherein the carrier material is a polymer material.

3. The additive formulation of claim 1 wherein the carrier material is a cementitious material.

4. The additive formulation of claim 1 wherein the carrier material is a liquid material.

5. The additive formulation of claim 4 wherein the liquid material is an aqueous liquid material.

6. The additive formulation of claim 1 wherein the first tracer is a zirconium compound.

7. A method for detecting an additive in a manufactured article, compromising:
applying an X-ray fluorescence input radiation to a manufactured article;
detecting an X-ray fluorescence output radiation from the article;
correlating the output radiation with a presence or absence of a first tracer element; and
correlating the presence or absence of the first tracer element with a presence or absence of the additive in the manufactured article.

8. The method of claim 7 wherein the first tracer element is a zirconium compound.

9. The method of claim 7, further comprising:
correlating a strength of the output radiation with at least one of a detected first tracer element concentration in the manufactured article or a calculated concentration of additive in the manufactured article.

10. The method of claim 9 wherein correlating a strength of the output radiation with a calculated concentration of additive is achieved based on a known relationship between additive concentration and first tracer element concentration in a raw material from which the article was manufactured.

11. The method of claim 7, further comprising:
correlating a strength of the output radiation with a detected first tracer element concentration in the manufactured article ; and
calculating a calculated concentration of additive in the manufactured article based on a known relationship between additive concentration and first tracer element concentration in a raw material from which the article was manufactured.

12. The method of claim 7, further comprising:
detecting an X-ray fluorescence output radiation from the article;
correlating the output radiation with a presence or absence of a second tracer element; and
correlating the presence or absence of the second tracer element with a presence or absence of the additive in the manufactured article;
wherein the first and second tracer elements are non-identical compounds.

12. A manufactured article having incorporated therein the additive formulation of claim 1.

13. A manufactured article, comprising:
a carrier material;
a first additive present in the carrier material at a first additive concentration; and
a first tracer present in the carrier material at a first tracer concentration;
wherein the first tracer is a metal amenable to detection by X-ray fluorescence analysis.
